(19) United States
(12) Patent Application Publication
(10) Pub. No.: US 2025/0091131 A1
(43) Pub. Date: Mar. 20, 2025

(54) Ferrous alloy powder for additive manufacturing

(71) Applicant: ArcelorMittal, Luxembourg (LU)

(72) Inventors: Frédéric BONNET, Avril (FR); Valérie DAESCHLER, Roncourt (FR); Luis Miguel SANZ MORAL, Gozon, Asturias (ES); Rosalía REMENTERIA FERNANDEZ, Avilés, Asturias (ES); Laura DEL RIO FERNANDEZ, Avilés, Asturias (ES)

(21) Appl. No.: 18/728,089

(22) PCT Filed: Jan. 31, 2023
(86) PCT No.: PCT/IB2023/050833

§ 371 Date: Jul. 11, 2024

(30) Foreign Application Priority Data
Jan. 31, 2022 (WO) PCT/IB2022/050815

(51) Int. Cl. B22F 9/08; B22F 1/05; B33Y 70/00; C22C 33/04

(52) U.S. Cl. CPC B22F 9/082; B22F 1/05; C22C 33/04; B22F 2009/0824; B22F 2301/35; B22F 2302/15; B22F 2302/20; B22F 2304/058; B33Y 70/00

(57) ABSTRACT

A ferrous alloy powder for additive manufacturing, obtained by atomization with a gas made of at least 95% in volume of nitrogen, the alloy including carbon up to 0.5 wt. %, titanium up to 11.0 wt. %, boron up to 5 wt. %, manganese up to 30 wt. %, aluminium up to 15 wt. %, silicon up to 1.5 wt. %, vanadium up to 0.5 wt. %, copper up to 2 wt. %, niobium up to 2 wt. %, the remainder being iron and residual elements, the powder including endogenous nitrides and/or carbonitrides of at least one element chosen among a group consisting of titanium, aluminium, boron, vanadium, silicon, and niobium, the nitrogen content of such ferrous alloy powder being above the solubility limit of nitrogen in such alloy, at the atomization temperature. A manufacturing method of such powder is also provided.

The present invention relates to a ferrous alloy powder for the manufacturing of parts and in particular for its use for additive manufacturing. The present invention also relates to the method for manufacturing the ferrous alloy powder.

### BACKGROUND

Ferrous alloy powders for additive manufacturing are usually being produced by an atomization process wherein fine metal droplets are obtained by forcing a molten alloy stream through a nozzle and by impinging it with jets of gas introduced into such stream just before it leaves the nozzle. Alloy droplets cool down during their fall in the atomizing tower, forming powder particles.

### SUMMARY OF THE INVENTION

The cooling rates that such powder particles are submitted to during their fall are very high due to the small size of the droplets and they are also not homogeneous from one particle to the other. This can lead to the formation of thermodynamically unstable microstructures with heterogeneous grain sizes. In some cases, some compounds that should precipitate during solidification are not formed.

When using such powder particles to manufacture a ferrous alloy part through additive manufacturing, the resulting parts can inherit from their inhomogeneity, leading to inhomogeneous use properties.

It is an object to the present invention to remedy such drawbacks by providing powders that can be efficiently used to manufacture parts by additive manufacturing methods while maintaining good use properties all over the parts.

The present provides a ferrous alloy powder for additive manufacturing, obtained by atomization with a gas made of at least 95% in volume of nitrogen, said alloy comprising carbon up to 0.5 wt. %, titanium up to 11.0 wt. %, boron up to 5 wt. %, manganese up to 30 wt. %, aluminium up to 15 wt. %, silicon up to 1.5 wt. %, vanadium up to 0.5 wt. %, copper up to 2 wt. %, niobium up to 2 wt. %, the remainder being iron and residual elements, said powder comprising endogenous nitrides and/or carbonitrides of at least one element chosen among a group consisting of titanium, aluminium, boron, vanadium, silicon, and niobium, the nitrogen content of such ferrous alloy powder being above the solubility limit of nitrogen in such alloy, at the atomization temperature.

A second subject of the invention consists of a manufacturing method of a ferrous alloy.

A third subject of the invention consists of a metal part manufactured by an additive manufacturing process using a ferrous alloy powder according to the invention or obtained through the method according to the invention.

### BRIEF DESCRIPTION OF THE DRAWINGS

The invention will be better understood by reading the following description, which is provided purely for purposes of explanation and is in no way intended to be restrictive, with reference to:

FIG. 1, which is a graph showing the nitrogen solubility limit in an iron and titanium alloy at 1600° C. as a function of the titanium content,

FIG. 2 showing a picture of Ti(C,N) inoculants inside a TiB2 precipitate and an enlargement of such picture.

### DETAILED DESCRIPTION

The ferrous alloy powder for additive manufacturing according to the invention comprises endogenous nitrides and/or carbonitrides of at least one element chosen among a group consisting of titanium, aluminium, boron, vanadium, silicon and niobium, the nitrogen content of such ferrous alloy powder being above the solubility limit of nitrogen, at the atomization temperature, in such alloy.

In standard ferrous alloy shop process, nitrogen content in the alloy cannot exceed its solubility limit in such alloy.

Nitrogen solubility limit in a given ferrous alloy depends on temperature, nitrogen partial pressure and alloying elements included in the alloy. Some alloying elements can increase (Cr, Al, Ti . . . ) or decrease (Si, C, P . . . ) nitrogen solubility.

Thermodynamic is well known to predict the effect of temperature, ferrous alloy composition, atmosphere composition and pressure on this solubility limit. In particular, as long as no nitride and/or carbonitride of formed, nitrogen solubility obeys Sievert's law, where the amount of nitrogen in the melt at a fixed temperature is inversely proportional to the square root of the partial pressure of the nitrogen in contact with the melt.

Beyond this solubility limit, some additional nitrogen can be incorporated into the ferrous alloy if it contains an alloying element that can generate stable nitrides or carbonitrides by precipitation. The total nitrogen content will then be the sum of nitrogen dissolved in liquid steel plus nitrogen precipitated as nitride or carbonitride. The density of nitrides or carbonitrides is generally lower than liquid steel, leading to flotation. Wettability of nitrides or carbonitrides by liquid steel is generally bad leading to clustering.

Whatever the composition of the ferrous alloy, standard steel shop practices prevent to reach high nitrogen content and/or good distribution of nitrides or carbonitrides after solidification.

However, it was newly discovered that a specific atomization process applied on appropriate ferrous alloy powders leads to the precipitation of endogenous nitrides and/or carbonitrides, the nitrogen content of such ferrous alloy powder being above the solubility limit of nitrogen, at the atomization temperature, in such alloy. Such nitrides and/or carbonitrides are homogeneously distributed in the powder.

Nitrogen can be introduced in the ferrous alloy during the elaboration of the molten alloy containing at least one element selected among titanium, aluminium, boron, vanadium, silicon and niobium, up to the limit of solubility predicted by thermodynamics. However, during the atomization process, a complementary addition of nitrogen can be done by controlling the atomization gas composition, so that it contains at least 95% in volume of nitrogen, by setting the atomization temperature to at least 1700° C. and by setting the superheat temperature at least 100° C. above the liquidus.

Without being bound by a theory, it seems that precipitation of nitrides and/or carbonitrides with at least one element selected among titanium, aluminium, boron, vanadium, silicon and niobium, occurs at the surface of the liquid droplets before being absorbed by such droplets, leading to fine and homogeneous dispersion of such endogenous nitrides and/or carbonitrides in the powder particles.

It has then been observed that such nitrides and/or carbonitrides are modifying the solidification mechanism within the droplets and can act as inoculants of precipitates.

The powder particles thus obtained show microstructures that are more homogeneous in phases and/or precipitates, leading to the manufacturing of parts showing more homogeneous use properties.

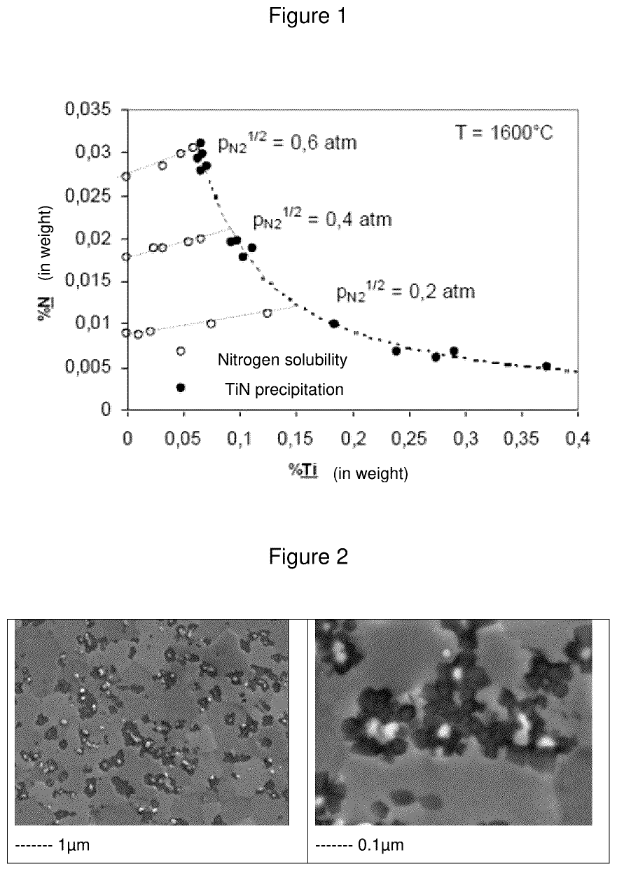

As represented on FIG. 1, the solubility limit curve of nitrogen in a ferrous alloy, like for instance iron+titanium, can be drawn as a function of the content of titanium which can precipitate to form nitrides and/or carbonitrides. This curve materializes the border between the zone where nitrogen is fully dissolved in solid solution in the alloy (below the curve) and the zone where precipitation occurs (above the curve).

In a preferred embodiment, the nitrides and/or carbonitrides formed inside the powder particles can be selected among AlN, BN, NbN, Si₃N₄, Ti(C,N) TiN, VN and V(C,N).

In a most preferred embodiment, the nitrides and/or carbonitrides formed inside the powder particles can be selected among NbN, TiN, Ti(C,N), VN and V(C,N).

The powder can be obtained, for example, by first mixing and melting pure elements and/or ferroalloys as raw materials. Alternatively, the powder can be obtained by melting pre-alloyed compositions.

Pure elements are usually preferred to avoid having too many impurities coming from the ferroalloys, as these impurities might ease the crystallization. Nevertheless, in the case of the present invention, it has been observed that the impurities coming from the ferroalloys were not detrimental to the achievement of the invention.

The person skilled in the art knows how to mix different ferroalloys and pure elements to reach a targeted composition.

The invention applies to ferrous alloys compositions comprising carbon up to 0.3 or up to 0.5 wt. %, titanium up to 11.0 or up to 5.0 or up to 2.0 wt. %, boron up to 5 or up to 3 or up to 1 wt. %, manganese up to 30, or up to 20 or up to 1 or up to 0.5 wt. %, aluminium up to 15 or up to 10 wt. %, silicon up to 1.5 wt. %, vanadium up to 0.5 wt. %, copper up to 2 wt. %, niobium up to 2 or up to 1 or up to 0.5 wt. %, the remainder being iron and residual elements.

In a preferred embodiment, the minimum amount of carbon is set to 0.001 wt. %. In a preferred embodiment, the minimum amount of aluminium is set to 0.001 wt. %. In a preferred embodiment, the minimum amount of titanium is set to 0.001 or to 0.1 or to 0.5 wt. %. In a preferred embodiment, the minimum amount of silicon is set to 0.001 wt. %.

Once the composition has been obtained by the mixing of the pure elements and/or ferroalloys in appropriate proportions, the composition is heated at a temperature at least 100° C. above its liquidus temperature and maintained at this temperature to melt all the raw materials and homogenize the melt. The temperature of the melt has to be above 1700° C. and preferably above 1750° C. Thanks to this overheating and specific temperature of atomization, the decrease in viscosity of the melted composition helps obtaining a powder with good properties. That said, as the surface tension increases with temperature, it is preferred not to heat the composition at a temperature more than 450° C. above its liquidus temperature.

Preferably, the composition is heated at a temperature at least 100° C. or even better 200° C. above its liquidus temperature. More preferably, the composition is heated at a temperature 300 to 400° C. above its liquidus temperature.

The molten composition is then atomized into fine alloy droplets by forcing a molten alloy stream through an orifice, the nozzle, at moderate pressures and by impinging it with jets of gas (gas atomization) or of water (water atomization). In the case of the gas atomization, the gas is introduced into the metal stream just before it leaves the nozzle, serving to create turbulence as the entrained gas expands (due to heating) and exits into a large collection volume, the atomizing tower. The latter is filled with gas to promote further turbulence of the molten metal jet. The alloy droplets cool down during their fall in the atomizing tower. Gas atomization is preferred because it favors the production of powder particles having a high degree of roundness and a low amount of satellites.

The atomization gas contains at least 95% in volume of nitrogen and optionally up to 5% in volume of an inert gas, like argon for instance. Argon increases the melt viscosity slower than other gases, e.g. helium, which promotes the formation of smaller particle sizes. Depending on the quantity of nitrides and/or carbonitrides to be introduced in the powder, the proportion of nitrogen can be increased up to 100% in volume.

The gas pressure is of importance since it directly impacts the particle size distribution and the microstructure of the powder. In particular, the higher the pressure, the higher the cooling rate. Consequently, the gas pressure is usually set from 10 to 30 bar to optimize the particle size distribution and favor the formation of the micro/nano-crystalline phase. Preferably, the gas pressure is set from 14 to 26 bar to promote the formation of particles whose size is most compatible with the additive manufacturing techniques.

The nozzle diameter has a direct impact on the molten alloy flow rate and, thus, on the particle size distribution and on the cooling rate. The maximum nozzle diameter is usually limited to 4 mm to limit the increase in mean particle size and the decrease in cooling rate. The nozzle diameter is preferably from 2 to 3 mm to more accurately control the particle size distribution and favor the formation of the specific microstructure.

The gas to metal ratio, defined as the ratio between the gas flow rate (in Kg/h) and the metal flow rate (in Kg/h), is preferably kept from 1.5 to 7, more preferably from 3 to 4. It helps adjusting the cooling rate and thus further promotes the formation of the specific microstructure.

According to one variant of the invention, in the event of humidity uptake, the alloy powder obtained by atomization is dried to further improve its flowability. Drying is preferably done at 100° C. in a vacuum chamber.

The alloy powder obtained by atomization can be either used as such or can be sieved to keep the particles whose size better fits the additive manufacturing technique to be used afterwards. For example, in case of additive manufacturing by Powder Bed Fusion, the range 20-63 μm is preferred. In the case of additive manufacturing by Laser Metal Deposition or Direct Metal Deposition, the range 45-150 μm is preferred.

The parts made of the metal powder according to the invention can be obtained by additive manufacturing techniques such as Laser Powder Bed Fusion (LPBF), Direct metal laser sintering (DMLS), Electron beam melting (EBM), Selective heat sintering (SHS), Selective laser sintering (SLS), Laser Metal Deposition (LMD), Direct Metal Deposition (DMD), Direct Metal Laser Melting (DMLM), Direct Metal Printing (DMP), Laser Cladding (LC), Binder Jetting (BJ), Coatings made of the metal powder according to the invention can also be obtained by manufacturing techniques such as Cold Spray, Thermal Spray, High Velocity Oxygen Fuel.

### EXAMPLES

The following examples and tests presented hereunder are non-restricting in nature and must be considered for purposes of illustration only. They will illustrate the advantageous features of the present invention, the significance of the parameters chosen by inventors after extensive experiments and further establish the properties that can be achieved by the alloy powder according to the invention.

Alloy compositions according to Table 1 were first obtained either by mixing and melting ferroalloys and pure elements in the appropriate proportions or by melting pre-alloyed compositions. The composition, in weight percentage, of the added elements are gathered in Table 1.

TABLE 1
Melt composition

| Sample | C | Ti | B | Mn | Al | Si | V | S | P | Ni | Cr | Cu |
|---|---|---|---|---|---|---|---|---|---|---|---|---|
| F103 | 0.044 | 5.88 | 1.679 | 0.00 | 0.33 | 0.44 | 0.22 | 0.006 | 0.002 | 0 | 0 | 0 |
| F157 | 0.021 | 5.99 | 1.963 | 0.19 | 0.11 | 0.07 | 0.05 | 0.002 | 0.009 | 0.04 | 0.03 | 0.05 |
| C76 | 0.053 | 5.71 | 2.195 | 0 | 0.32 | 0.57 | 0.21 | 0.007 | 0.002 | 0 | 0 | 0 |
| C238 | 0.062 | 10.35 | 3.900 | 0.06 | 0.03 | 0.10 | 0.21 | 0.006 | 0.006 | 0.01 | 0.07 | 0.02 |
| C261 | 0.061 | 9.89 | 4.139 | 0.15 | 0.32 | 0.11 | 0.23 | \|0.001 | 0.007 | 0.04 | 0.03 | 0.04 |
| 179 | 0.002 | 1.00 | 0 | 0 | 0.05 | 0.01 | 0 | 0.001 | 0.001 | 0 | 0 | 0 |

These alloy compositions were heated up and then gas atomized in the process conditions gathered in Table 2.

TABLE 22
Atomization parameters

| | Overheat | Holding | Atom T | Atom | Gas T | Atom t, | | | | F3-4, |
|---|---|---|---|---|---|---|---|---|---|---|
| Batch | T (° C.) | t (min) | ° C. | gas | ° C. | mm:ss | F1, % | F2, % | F3, % | % |
| F103 | 236 | 60 | 1645 | Argon | n/a | 01:24 | 78.5 | 13.8 | 28.6 | |
| F157 | 122 | 30 | 1641 | Argon | n/a | 01:20 | 90.8 | 18 | 43.2 | |
| C76 | 117 | 45 | 1544 | Argon | 200 | 00:59 | 85.4 | 15.6 | 36.2 | |
| C238* | 333 | 15 | 1821 | Nitrogen | n/a | 02:23 | 36.5 | 33.3 | 15.6 | |
| C261* | 217 | 40 | 1803 | Nitrogen | n/a | 02:30 | 15.14 | 34.27 | 0 | 41.84 |
| 179* | 238 | 6 | 1763 | Nitrogen | n/a | 2:25 | 12.04 | 31.12 | 0 | 51.37 |

RT means room temperature,
*according to the invention

For all trials, the common input parameters of the atomizer BluePower AU3000 were:

| Start ΔP | 60 | mbar |
|---|---|---|
| End ΔP | 140 | mbar |
| Time ΔP | 1.5 | min |
| Gas Pressure | 24 | bar |
| Gas Start Delay Time | 1-2 | s |
| Crucible/Stopper Rod Material | Al₂O₃/Al₂O₃ | |
| Crucible Outlet Diameter | 3.0 | mm |

| | |
|---|---|
| Crucible Outlet Material | Boron Nitride |

The obtained alloy powders were then dried at 100° C. under vacuum for 0.5 to 1 day and sieved to be separated in according to their size. F1 fraction is made of particles with a size below 20 μm. F2 fraction is made of particles with a size from 20 to 63 μm. F3 fraction is made of particles with a size above 63 to 160 μm. F4 fraction is made of particles with a size above 160 μm. Fraction noted F3-4 is made of the particles with a size above 63 μm.

TABLE 3
Powders characterization of F2 fractions

| | | | | | N | C | Nitride/ | Wt. % | Solubility |
|---|---|---|---|---|---|---|---|---|---|
| | Ti | B | TiB₂ | | content | content | carbonitride | Nitride/ | limit for N |
| Sample | (wt %) | (wt %) | (% vol) | Fe₂B | (ppm) | (wt. %) | nature | carbonitride | (ppm) |
| F103 | 5.34 | 1.73 | 9.29 | None | 22 | 0.047 | — | 0 | 29 |
| F157 | 5.84 | 2.05 | 10.9 | None | 16 | 0.074 | — | 0 | 18 |
| C76 | 3.22 | 1.52 | 8 | Yes | 20 | 0.027 | — | 0 | 21 |
| C238* | 3.85 | 3.93 | 12.8 | Yes | 450 | 0.011 | TiN | 0.210 | 5 |
| C261* | 9.07 | 3.98 | 20.3 | Yes | 990 | 0.104 | Ti(C,N) | 0.867 | <1 |

*according to the invention

N content is measured with standard Leco gas analyzer method. Nitrogen solubility at the atomization temperature is calculated based on thermodynamic calculations. Nature of nitride and carbonitride is predicted based on thermodynamic calculations. Size of nitride and carbonitride was measured through scanning electron microscopy observations and is below 0.5 μm for all trials.

For FeTiB₂, presence of Fe2B was determined by classical metallography methods based on polishing and etching. Weight percentages of Ti and B are measured by ICP-Optical Electron Spectroscopy. Volume percentages of TiB2 is calculated based on mass balance or by image analysis (thresholding method) on classical metallography.

### FeTiB₂

Precipitation of nitride or carbonitride can be used to inoculate the microstructure during solidification or solid phase transformation. As seen on FIG. 2 showing pictures of a FeTiB₂ powder produced according to the invention, carbonitrides appearing as white areas are usually observed inside TiB₂ as inoculant (appearing as dark areas).

For some other grades with various types of composition, precipitation of different compounds was observed, and the nitrogen contents were measured and are above the solubility limits, as shown in the table below:

TABLE 4
Powders characterization of other fractions

| | Ti | N content | C content | Solubility limit |
|---|---|---|---|---|
| Sample | (wt %) | (ppm) | (wt. %) | for N (ppm) |
| 179* | 0.8 | 430 | 0.002 | 197 |

*according to the invention

Some additional characterizations were done on fractions F1, F3 and/or F4 of some of the trials:

| Sample | Fraction | Ti (wt. %) | B (wt. %) | N content (ppm) |
|---|---|---|---|---|
| C238* | F1 | 3.91 | 3.98 | 550 |
| C238* | F3 | 3.81 | 3.92 | 440 |
| C261* | F1 | 9.34 | 3.95 | 1170 |
| C261* | F3 | 9.73 | 3.97 | 1000 |

*according to the invention

It can be observed that, after atomization in nitrogen atmosphere, the nitrogen content of the powder is stable whatever the size of the powder and the rate of solidification. No effect of powder granulometry and associated solidification rate on the nitrogen content of powders is observed. Nitrogen is precipitated inside the grain powder and its content is independent of specific surface of the powder.

1-7. (canceled)

8. A ferrous alloy powder for additive manufacturing, obtained by atomization of an alloy with a gas made of at least 95% in volume of nitrogen, the alloy comprising carbon up to 0.5 wt. %, titanium up to 11.0 wt. %, boron up to 5 wt. %, manganese up to 30 wt. %, aluminium up to 15 wt. %, silicon up to 1.5 wt. %, vanadium up to 0.5 wt. %, copper up to 2 wt. %, niobium up to 2 wt. %, a remainder being iron and residual elements, the ferrous allow powder comprising endogenous nitrides or carbonitrides of at least one element chosen among a group consisting of titanium, aluminium, boron, vanadium, silicon, and niobium, a nitrogen content of the ferrous alloy powder being above the solubility limit of nitrogen in the alloy, at an atomization temperature.

9. The ferrous alloy powder as recited in claim 8 wherein the average size of such nitrides or carbonitrides is below 0.5 μm.

10. The ferrous alloy powder as recited in claim 8 wherein the endogenous nitrides or carbonitrides are included in precipitates as inoculants.

11. The ferrous alloy powder as recited in claim 8 wherein the nitrides or carbonitrides are distributed inside the powder particles and selected among AlN, B(C,N), Nb(C,N), Si₃N₄, TiN, Ti(C,N), VN and V(C,N).

12. The ferrous alloy powder as recited in claim 11 wherein the nitrides or carbonitrides are TiN or Ti(C,N).

13. A method for manufacturing the ferrous alloy powder as recited in claim 11 for additive manufacturing, the method comprising:
melting elements or metal-alloys comprising at least one element chosen among a group consisting of titanium, aluminium, boron, vanadium, silicon, and niobium, at a temperature at least 100° C. above the liquidus temperature and above 1700° C., so as to obtain a molten composition; and
atomizing the molten composition through a nozzle with a gas made of at least 95% in volume of nitrogen and optionally up to 5% in volume of an inert gas.

14. A ferrous alloy part manufactured by an additive manufacturing process and comprising the ferrous alloy powder as recited in claim 8.

15. A ferrous alloy part manufactured by an additive manufacturing process and obtained through the method as recited in claim 13.
